(19) United States
(12) Patent Application Publication
(10) Pub. No.: US 2015/0274092 A1
(43) Pub. Date: Oct. 1, 2015

(54) METHOD AND DEVICE FOR FORMING A COMPOSITE MATERIAL

(71) Applicant: FORD GLOBAL TECHNOLOGIES, LLC, Dearborn, MI (US)

(72) Inventors: MURPHY YANG, NANJING (CN); LISA LV, NANJING (CN); KADIN ZHANG, NANJING (CN)

(21) Appl. No.: 14/515,592

(22) Filed: Oct. 16, 2014

(30) Foreign Application Priority Data
Mar. 26, 2014 (CN) 201410116473.8

(51) Int. Cl. B60R 13/02; B32B 37/18; B32B 38/00

(52) U.S. Cl. CPC B60R 13/0212; B32B 38/0012; B32B 37/18

(57) ABSTRACT

In one or more embodiments, a method of forming a composite material is provided, including: placing a substrate layer and a material layer into a cavity of a forming device; heating the forming device to partially form the substrate layer and the material layer; controlling the temperature of a predetermined position of the cavity to be lower than a forming temperature of the substrate layer and the material layer to avoid forming of the substrate layer and the material layer at the predetermined position.

### RELATED APPLICATION(S)

This application claims the benefit of Chinese New Invention Patent Application No.: CN 201410116473.8, filed on Mar. 26, 2014, the entire contents thereof being incorporated herein by reference.

### TECHNICAL FIELD

The disclosed inventive concept relates generally to a method and device for forming a composite material, in particular a method and device for forming a vehicle headliner.

### BACKGROUND

Nowadays, vehicle headliners are normally equipped in vehicles to provide comfort and an aesthetic appeal. Headliners are often of multilayered structure to enhance performance in sound-proofing and heat resistance, for instance. Therefore, to form headliners with good appearance, especially to form the front and back edges of the headliners that are in contact with the windshields, it's desirable to wrap the edge of headliners during manufacturing. Additionally, many vehicles on market are equipped with sunroofs to enhance driving experience such as enhanced light and air flow for providing better appearance and comfort. Therefore, an opening for sunroof is often desirable on the headliner and it's also desirable to have the edges of the opening wrapped for improved appearances.

U.S. Pat. No. 5,134,014 discloses a heat moldable composite panel formed by placing a covering layer and a foam composite core with thermoplastic adhesive into a molding device. PCT application No. WO200609031 discloses a multilayered automobile headliner, wherein a thermoplastic organic fiber enhanced composite is formed by mixing different proportions of shell and core component plus fibers, and wherein products may be formed through a continuous processing unit having a heat combining unit.

### SUMMARY

One or more embodiments of the present invention relates to a method and device for forming composite material and in particular for forming a vehicle headliner.

According to one aspect of the present invention, a method of forming composite material includes placing a substrate layer and a material layer into a cavity of a forming device, heating the forming device to partially form the substrate layer and the material layer, controlling the temperature of a predetermined position of the cavity to be lower than a forming temperature of the substrate layer to avoid forming of the substrate layer and the material layer at the predetermined position.

In one or more embodiments, the step of controlling further includes providing heat-resistant materials at a location in the forming device corresponding to the predetermined position.

In another one or more embodiments, the step of controlling further includes providing heat-resistant material at a location of one or both of the substrate layer and the material layer corresponding to the predetermined position.

In yet another one or more embodiments, the step of controlling further includes providing a cooling medium at a location of the forming device corresponding to the predetermined position.

In yet another one or more embodiments, the method further includes cutting an unformed portion of the substrate layer so as to provide the substrate layer and the material layer each with an end of different length relative to each other.

According to another aspect of the present invention, a forming device for forming a composite material includes a first forming part, a second forming part, wherein the first and second forming parts define a cavity to receive the composite material, and wherein at least one of the first and second forming parts includes a first material corresponding to a first point of the cavity and a second material corresponding to a second point of the cavity, the first material being different than the second material in heat-conductivity.

In one or more embodiments, the first material includes heat resistant material.

In another one or more embodiments, the heat resistant material has a heat conducting coefficient of not more than 0.3 W/(m·K).

In yet another one or more embodiments, the heat resistant material is configured as a heat resistant material layer with a thickness of more than 2 millimeters.

In yet another one or more embodiments, at least a portion of the heat resistant material is positioned within the cavity defined by the first and second forming parts.

In yet another one or more embodiments, at least a portion of the heat resistant material is external to at least one of the first and second forming parts.

In another one or more embodiments, the heat resistant material is configured as particles.

In another one or more embodiments, the forming device further includes a cooling medium positioned at the first position.

In another one or more embodiments, the forming device further includes a protrusion positioned between the first position and the second position.

In yet another one or more embodiments, at least a portion of the protrusion is positioned within the cavity. In certain particular embodiments, the cavity of the forming device is of a shape corresponding to a shape of a vehicle headliner.

The method provided herewith may involve relatively fewer steps and the forming device provided herewith is of a relatively simple structural design. With a forming device thus provided, one would be able to selectively form a composite material at a predetermined portion. The forming method and forming device according to one or more embodiments of the present invention may provide products with wrapped “edges” (or “ends”) with good appearance while maintaining desirable cost efficiency.

It is appreciated that the Summary provided above is to briefly introduce a few concepts that are further described in the Detailed Description. It is not meant to identify key or essential features of the claimed subject matter, the scope of which is defined uniquely by the Claims that follow the detailed description. Furthermore, the claimed subject matter is not limited to any particular examples described herein.

The above advantages and other advantages and features will be readily apparent from the following detailed description of embodiments when taken in connection with the accompanying drawings.

### BRIEF DESCRIPTION OF THE DRAWINGS

For a more complete understanding of embodiments of this invention, reference should now be made to the embodiments illustrated in greater detail in the accompanying drawings and described below by way of examples wherein:

FIG. 1 illustratively depicts a vehicle headliner according to one or more embodiments of the present invention;

FIG. 2A illustratively depicts a sectional view of a composite material formed that may be used for producing the vehicle headliner referenced in FIG. 1;

FIG. 2B illustratively depicts a sectional view of composite materials that may be used for forming the headliner referenced in FIG. 1;

FIG. 3A illustratively depicts an enlarged sectional view along line A-A of the composite material referenced in FIG. 2A;

FIG. 3B illustratively depicts an enlarged sectional view of an alternative design of the composite material referenced in FIG. 3A;

FIG. 4A to FIG. 4C illustratively depict non-limiting process steps for forming the composite material referenced in FIG. 2A and/or FIG. 2B; and

FIG. 5 illustratively depicts non-limiting process steps for forming the headliner referenced in FIG. 1.

### DETAILED DESCRIPTION OF ONE OR MORE EMBODIMENTS

As referenced in the FIG.s, the same reference numerals are used to refer to the same components. In the following description, various operating parameters and components are described for different constructed embodiments. These specific parameters and components are included as examples and are not meant to be limiting.

The disclosed inventive concept is believed to have overcome one or more of the problems associated with known production of a composite material, in particular a vehicle headliner.

One or more embodiments of the present invention are disclosed herein. However, it is appreciated that the disclosed embodiments are merely exemplary, and the invention may be embodied in various and alternative forms. The figures are not necessarily to scale; some features may be exaggerated or minimized to show details of particular components. Therefore, specific structural and functional details disclosed herein are not to be interpreted as limiting, but merely representative of ways to carry out the present invention.

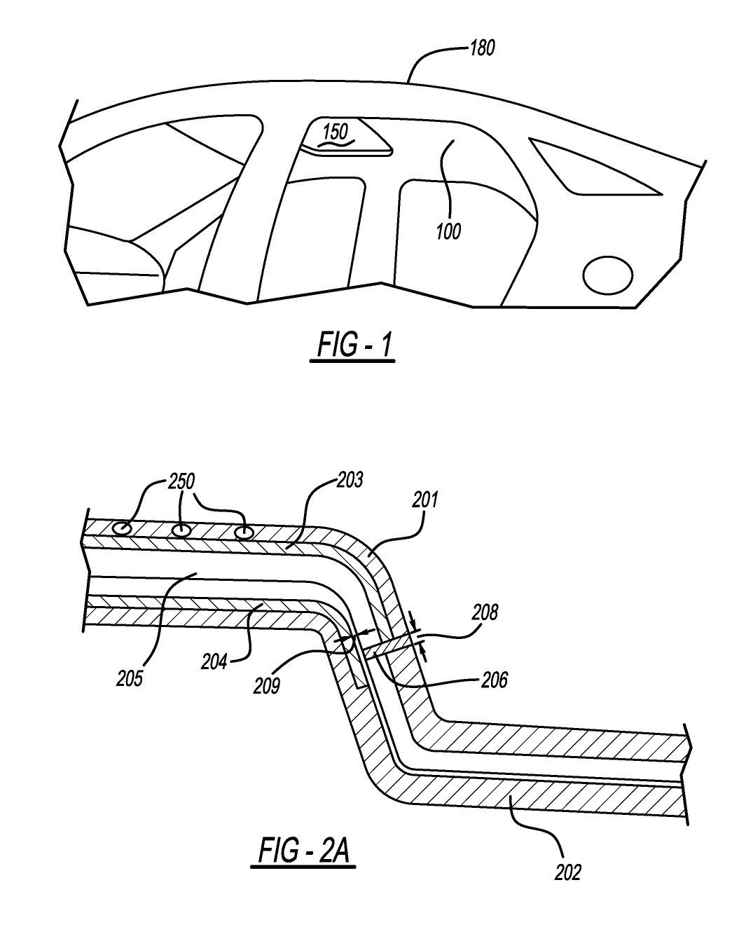

FIG. 1 illustratively depicts a vehicle headliner 100 as positioned within a vehicle 180, wherein the headliner may be located at an inner top of the vehicle. The vehicle 180 may further include a sunroof 150. An opening may be provided on the headliner 100 for installing the sunroof 150.

To form a headliner 100 as illustratively depicted in FIG. 1, complicated forming devices and processes would ordinarily be required to provide the headliner with desirably wrapped edges. Specifically, some existing forming methods include one or more of the following steps: firstly heat-pressing composite material layers in a first set of forming device to form a substrate layer; then cutting the substrate layer into desired shape (for instance, in some vehicles where a sunroof is needed, the substrate layer is cut to provide opening for installing the sunroof); then heat-pressing the substrate layer with a covering layer in another forming device; then cutting the covering layer to maintain edge margin for wrapping the substrate edge near the front and back windshields and sunroof opening areas. Inventors of the present invention have realized the complexity of the above mentioned method and forming devices, and have provided a method and device for forming a composite material. The present invention in one or more embodiments is explained in more details with following examples in view of the drawings.

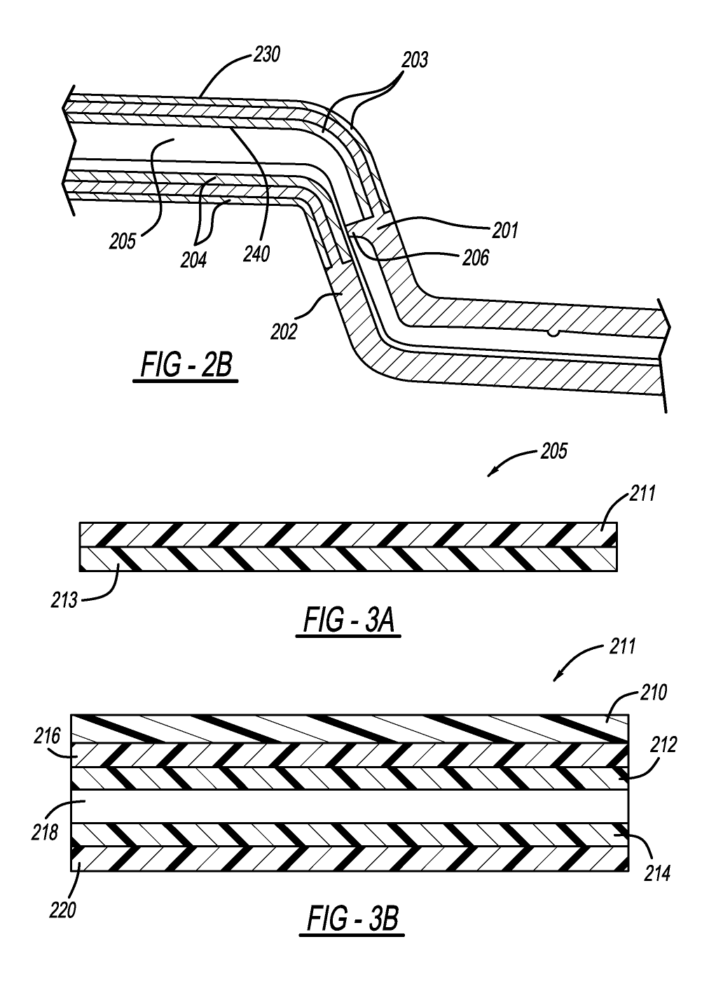

In particular, FIG. 2A illustratively depicts a sectional view of a composite material formed in a forming device. A portion of the first forming part 201 and the second forming part 202 may independently or jointly be provided with heat resistant material 203, 204. The first forming part 201 and the second forming part 202 may alternatively be referred to as upper forming part 201 and lower forming part 202. Term “forming part” does not necessarily represent or restrict the size of the forming device. Additionally, “upper” or “lower” does not necessarily represent the relative location of the forming parts. Heat resistant material 203, 204 have a different heat conducting coefficient relative to other portions of the upper forming part 201 and/or lower forming part 202. In other words, the difference in heat conductivity effectuated by the presence of the heat-resistant material 203 and/or 204 provides a localized area within the forming cavity where the to-be-formed composite material layers 205 are not heat-formed.

Referring back to FIG. 2A, the upper forming part 201 and the lower forming part 202 may respectively be provided with heat resistant material layers 203, 204 at predetermined positions, wherein a composite material layer 205 having two or more layers are positioned in the cavity defined by the upper forming part 201 and the lower forming part 202. Under certain operating conditions, for instance, by increasing the temperature of the forming device or increasing the pressure, the composite material layers 205 are formed partially, while the temperature of the composite material layers 205 at the location where the heat resistant material layers 203, 204 are provided is lower than the forming temperature of the composite material layers 205, thereby the composite material layers 205 remain unformed at the above-mentioned predetermined location but are heat formed at other locations. In certain instances, a cooling medium may be provided at or near the predetermined position such that a corresponding temperature may be controlled to effectuate the non-forming. One non-limiting example is to provide a cooling channel 250 so as to provide better temperature reducing effects at the predetermined positions. The cooling medium may be of any suitable material, with non-limiting examples including cold or refrigerated liquids, in particular cold or refrigerated water.

FIG. 2B illustratively depicts another example of the present invention, with comparative view in relation to FIG. 2A. As illustratively depicted in FIG. 2B, heat resistant layers 203, 204 are arranged at a location 230 external to and at a location 240 inside of the upper forming part 201 and the lower forming part 202, respectively. To provide desirable effects in heat resistance, the heat resistant layers may be arranged at the location 230 external to the forming device, and/or be arranged at the location 240 inside of the forming device. Additionally, cooling channels 250 may be provided at one or more of the predetermined locations mentioned herein to deliver temperature control as needed. Further, the term “forming” and/or the term “reaction” described herein in relation to the composite material 205 may refer to one or more chemical reactions, such as surface cross-linking reactions or physical bonding formed by via heat induced curing.

In one or more embodiments, the heat resistant layers 203, 204 may each independently be pre-arranged in the predetermined position in the forming device. The predetermined position may be varied according to a particular design need. For instance and as illustratively depicted in FIGS. 2A and 2B, a protrusion 206 may be arranged at the predetermined position, such that a cutting groove is formed on the composite material 205, where the cutting and folding may thereafter take place. In this connection, the predetermined position may be positioned to the left or the right relative to a viewer, dependent upon how much of the remaining folding material is needed.

Although much of the discussion provided herein is somewhat directed to the vehicle interior part 100 referenced in FIG. 1, it is however to be appreciated that the vehicle interior part 100 is only a non-limiting example of the composite material 205. In other words, the composite material 205 may be used for any suitable purposes and in any suitable carriers such as cars, airplanes, and household furniture.

Referring back to FIG. 2B, the heat resistant material may be arranged at a location 240 inside to and/or at a location 230 external to the forming device, or it can be a portion of the forming device. For instance, it may be configured as particles and distributed in a predetermined position of the forming device. As mentioned herein elsewhere, the predetermined position may be varied according to the particular design as needed. In certain instances, the predetermined position corresponds to a sun-roof opening area in the headliner of a vehicle, or the edge areas of the headliner of a vehicle. In one headliner forming example where sun-roof is provided, heat resistant material is provided at the position corresponding to the sun-roof area according to the design, and the size of the position where heat resistant material is provided matches the sun-roof area.

In certain embodiments, the heat resistant layers may be of materials with a heat conducting coefficient equals to or smaller than 0.3 W/(m·K). The heat conducting coefficient may be an intrinsic characteristic of the material, and different materials often have different coefficients. Any suitable heat conducting coefficient testing device may be used to measure or determine the heat conducting coefficient of a material. A non-limiting example of the testing device includes US Anter (TA) FL4010 testing machine from US Anter company. Any suitable heat resistant materials may be used, with non-limiting examples thereof including temperature heat resistant mats provided by Furtech company in Shenzhen China, such as “Naji” heat resistant mat that is resistant to a temperature of up to 650° C., “Paiji” heat resistant mat that is resistant to a temperature of up to 385-650° C., “micronano” heat resistant sheet that is resistant to a temperature of up to 800-1000° C. It is appreciated that different heat resistant materials may be selected dependent upon the reaction temperature of the to-be-formed materials. For instance, heat reaction temperatures for the forming device are 120-150° C. and the heat adhesive agent may be activated at a temperature greater than 50° C. with water to form/attach relative material layers, and materials with a heat conducting coefficient equal to or smaller than 0.3 W/(m·K) may be selected and used. The heat resistant materials such as heat resistant mats may be provided at the predetermined positions such that the forming reactions at the predetermined positions is much reduced or completely prevented. The heat resistant materials can be provided on/within the material layers to deliver the heat resistant performance. While by providing heat resistant materials 203, 204 in or on the forming device, specific/exact heat resistant positions may be controlled more precisely during the manufacturing process. By placing the heat resistant material in/on the forming device, movement of the to-be-formed composite material layers during processing does not negatively affect the heat-resistant positions and therefore the process is more reliable. Therefore, repeat processing is permissible and cost efficiency may be realized.

Composite material 205 (to-be-formed) may include two or more material layers. In one example and as illustratively depicted in FIG. 3A, an enlarged partial view along line A-A of the composite material referenced in FIG. 2A is shown, wherein composite material 205 is depicted to include a substrate layer 211 and a material layer 213. The material layer 213 may be a facing material layer, for instance, it may be a fabric layer or other materials with good or desirable appearance. As may be mentioned herein elsewhere, an elevation in operating temperature effectuates a partial forming of the substrate layer 211 and the material layer 213, while at certain predetermined locations provided with the heat resistant material layer 203, 204, the forming does not effectively occur as being avoided.

The substrate layer 211 of the composite material 205 may include one or more material sub-layers. For instance, and as illustratively depicted in FIG. 3B, the substrate layer 211 may include more than one, two or more layers of materials, and may include five layers of material in particular. Referring back to FIG. 3B, a first material layer 210 may be non-woven fabric layer, or other suitable material such as Kraft paper; a second material layer 216 may be glass fiber layer, or other strength-enhancing materials such as carbon fiber or boron fiber; a third layer 212 may be hot melt adhesive, such as polyurethane (PU) reactive hot melt adhesive, other types of adhesives such as ethylene-vinylacetate copolymer (EVA) adhesive, solvent-based polychloroprene adhesive, styrene-butadiene block copolymer (SBS), styrene-isoprene-styrene (SIS), polyester, or polyamide; a middle layer 218 may be of any suitable material such as a PU foam layer; a forth material layer 214 may be hot melt adhesive, which can be the same or different from the material forming the layer 212; and a fifth material layer 220 may be formed of materials similar to or different from the materials forming the layer 216, such as strength-enhancing materials such as carbon fiber and boron fiber. Although five layers are shown in relation to the substrate layer 211, the substrate layer 211 may include fewer or more than five layers as needed. In addition, functional materials such as glass fibers may be added to or replaced with any existing materials in the substrate layer to provide desirable performance in strength, sound absorbing or heat proofing. Moreover, certain catalytic agents such as water may be provided on the surface of hot melt adhesive to facilitate adhesion.

The above formed composite material layers may further be cut. Unlike certain existing processes which may include steps of: producing a substrate layer, cutting the formed substrate layer, forming the substrate layer with a face material, and cutting the face material, the present invention in one or more embodiments provide a simplified one-step forming process for the substrate layer and the face material, thereby only one cutting step may be required and that one cutting step may be performed after the substrate layer and the face material are partially formed. The cutting may be carried out using any suitable devices and methods. For instance, and referring back to FIG. 2A, to provide a vehicle headliner with a sun-roof, heat resistant materials 203, 204 are provided in the area corresponding to the sun-roof area, thereby the material in this area is cut in the later process and separate/unformed material edges/ends are provided in the inner peripheral surface of the sun-roof area. An outer edge of the material layer 213 is wrapped against other substrate layer 211 to provide a wrapped edge/end with better appearance. In the manufacturing process for a headliner that do not include a sun-roof, the present inventive method can also be utilized to provide better edge of the headliner at the surface contacting the front and back windshields. Specifically, heat resistant materials may be provided at both ends of the forming device and similarly to provide separate/unformed edges, and edge of material/facing layer may be wrapped against other substrate layers to provide smooth edge surfaces.

To facilitate the step of cutting, in one example, protrusion is provided in the forming part 201 and/or 202 to form cutting groove at predetermined positions so that the cutting may be carried out precisely at the groove at a later stage. Referring back to FIG. 2A, the upper forming part 201 is provided with a protrusion 206, and the protrusion 206 is spaced from the lower forming part 202 with certain distance 209, and it has certain width 208. The width 208 and distance 209 may respectively be of any suitable size. In some embodiments, width 208 may be 1 millimeter (mm) to 5 mm, and for instance 3 mm. While distance 209 may be related to the thickness of the material layer 213, it may be 0.5 to 1 in ratio of the thickness of the material layer/fabric layer 213, for instance 0.8 in ratio. It is operable that protrusions may not be needed in certain embodiments.

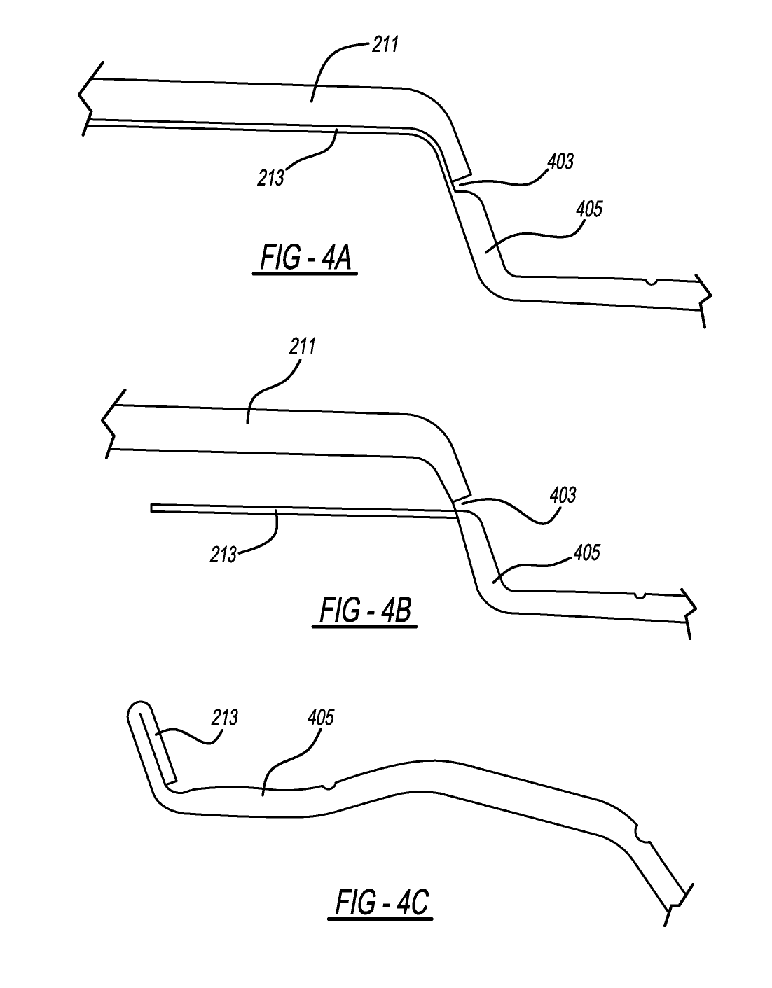

FIG. 4A through FIG. 4C illustratively depict various steps for post-processing the formed composite material referenced in FIG. 2A and FIG. 2B subsequent to its retrieval from the forming parts 201, 202. As illustratively depicted in FIG. 4A, the composite material is retrieved from the forming device. The composite materials formed at the location where heat resistant material layers 203, 204 are provided include at least unformed/uncombined/unattached material layer 213 and substrate layer 211, while the composite materials are formed to be one composite material 405 at other locations where heat resistant layers are not provided. In one example shown in FIG. 2A, protrusion 206 is formed in the forming device to form a cutting groove 403 as shown in FIG. 4A to facilitate the following step of cutting.

Subsequent to the step of cutting is step 508 referenced in the method 500. In certain embodiments, and in view of FIG. 4B, the material layer 213 is pulled to a separate position from the substrate layer 211, then the material layer 213 is cut via appropriate method and certain edge margin is reserved for edge wrapping. The substrate layer is then cut. Any suitable tools may be used to pull the material layer 213 so as to align the cutting position with the cutting groove 403 and perform a one-step cutting if needed.

Next, and as illustratively depicted in FIG. 4C, after the unwanted portion 211 is cut and removed, the exposed edge of the composite material or the headliner is wrapped by the material layer 213 (with an edge margin for edge wrapping) to form a smooth edge with good appearance. The step of wrapping may be carried out by any suitable wrapping devices. Adhesive is optionally applied to attach the face material layer to a surface of the formed material to facilitate the wrapping. In certain embodiments, heat may be applied in addition to the adhesive during wrapping. A plastic part may be provided at or near the edge of the face material layer to provide enhanced rigidity, strength and appearance. As illustratively depicted in FIG. 4C, heat formed product has a smooth edge with nice appearance, and the method provided according to one or more embodiments of the present invention avoid the use and hence the cost associated with additional molding, while the thickness of the wrapped edge as well as production stability is effectively controllable.

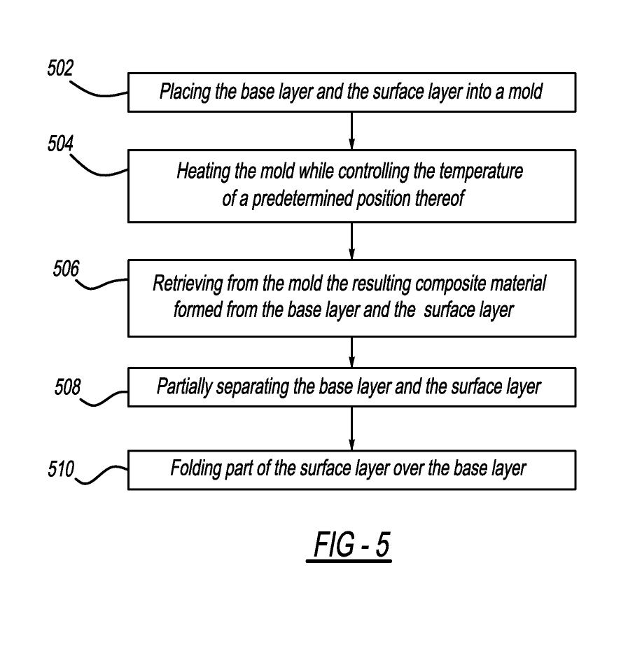

FIG. 5 illustratively depicts a flowchart for forming a composite material according to one or more embodiments of the present invention. At step 502, and in view of FIG. 3A, the substrate layer 211 and the material layer 213 for forming the composite material 205 are placed into the forming device parts 201, 202. The structure of the composite material 205 may be varied as needed. At step 504, one or both of the forming device parts 201, 202 are heated and an operating temperature is controlled at some predetermined positions such that composite materials are not formed at the predetermined positions while formed at other positions. Various methods may be adopted to control the temperature of the material at predetermined positions. For example, heat resistant materials 203, 204 or cooling medium may be provided in the forming device. It is appreciated that heat resistant material 203, 204 may be any suitable materials, and may be pre-arranged in the forming device 201, 202 for the convenience of following steps. The forming device is heated to form the composite materials partially. At step 506, the partially formed composite material is retrieved from the forming device. At step 508, in one example, unformed material layer 213 may be pulled and cut separately with certain wrapping margin of the edge being maintained. Then suitable cutting method may be employed to cut the substrate layer. It is appreciated that the sequence of cutting may be changed without affecting the present invention. At step 508, the edge of the material layer for wrapping has a different length, specifically the material layer 213 for wrapping has a relatively longer edge or end than other substrate/material layers. At step 510, material layer 213 or other material layer for wrapping is folded toward a direction further from itself to wrap the other material layers, for instance, the edge or end of the substrate layer is wrapped by the edge of the material layer. Any suitable methods may be employed for wrapping, and in particular, wrapping tooling may be used to heat and wrap material edge to the surface of the substrate layer that is further from the facing material layer.

The present invention in one or more embodiments is advantageous in that one forming device may be used via relatively simplified process to form an article such as a headliner with good appearance and stability. Any suitable techniques may be employed to carry out the following step of attaching the headliner to the roof of a vehicle, for instance, through binding, brackets, buckles or clamps. Although much of the description is directed to the formation of a vehicle headliner, it is appreciated that the inventive method described herein may be used to produce any other articles of a vehicle or articles of any other applications including furniture such as sofa, seat, interior of vehicle, boat, airplanes that may require hard formed sheets with good appearance.

The following claims particularly point out certain combinations and sub-combinations regarded as novel and nonobvious. These claims may refer to “an” element or “a first” element or the equivalent thereof. Such claims should be appreciated to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or otherwise different in scope relative to the original claims, also are regarded as included within the subject matter of the present disclosure.

In one or more embodiments, the disclosed invention as set forth herein is believed to have overcome the challenges faced by known production of a composite material, in particular a vehicle headliner. However, one skilled in the art will readily recognize from such discussion, and from the accompanying drawings and claims that various changes, modifications and variations can be made therein without departing from the true spirit and fair scope of the invention as defined by the following claims.

What is claimed is:

1. A method of forming a composite material, comprising:
placing a substrate layer and a material layer into a cavity of a forming device;
heating the forming device to partially form the substrate layer and the material layer;
controlling the temperature of a predetermined position of the cavity to be lower than a forming temperature of the substrate layer and the material layer to avoid forming of the substrate layer and the material layer at the predetermined position.

2. The method of claim 1, wherein the step of controlling further includes providing heat-resistant material at a location in the forming device corresponding to the predetermined position.

3. The method of claim 1, wherein the step of controlling further includes providing heat-resistant material at a location of the substrate layer and/or the material layer corresponding to the predetermined position.

4. The method of claim 1, wherein the step of controlling further includes providing a cooling medium at a location of the forming device corresponding to the predetermined position.

5. The method of claim 1 further comprising cutting an unformed portion of the substrate layer so as to provide the substrate layer and the material layer each with an end of different length relative to each other.

6. A forming device for forming a composite material, comprising:
a first forming part; and
a second forming part;
wherein the first and second forming parts define a cavity to receive the composite material, and wherein at least one of the first and second forming parts includes a first material corresponding to a first point of the cavity and a second material corresponding to a second point of the cavity, the first material being different than the second material in heat-conductivity.

7. The forming device of claim 6, wherein the first material includes heat resistant material.

8. The forming device of claim 7, wherein the heat resistant material has a heat conducting coefficient of not more than 0.3 W/(m·K).

9. The forming device of claim 7, wherein the heat resistant material is configured as a heat resistant material layer with a thickness of more than 2 millimeters.

10. The forming device of claim 7, wherein at least a portion of the heat resistant material is positioned within the cavity defined by the first and second forming parts.

11. The forming device of claim 7, wherein at least a portion of the heat resistant material is external to at least one of the first and second forming parts.

12. The forming device of claim 7, wherein the heat resistant material is configured as particles.

13. The forming device of claim 6, further comprising a cooling medium positioned at the first position.

14. The forming device of claim 6, further comprising a protrusion positioned between the first position and the second position.

15. The forming device of claim 14, wherein at least a portion of the protrusion is positioned within the cavity.

16. A forming device comprising:
a first forming part; and
a second forming part;
wherein the first and second forming parts define a cavity to receive the composite material, the cavity of the forming device being of a shape corresponding to a shape of a vehicle headliner, and wherein at least one of the first and second forming parts includes a first material corresponding to a first point of the cavity and a second material corresponding to a second point of the cavity, the first material including a heat resistant material and being different than the second material in heat-conductivity.

17. The forming device of claim 16, wherein at least a portion of the heat resistant material is positioned within the cavity defined by the first and second forming parts.

18. The forming device of claim 16, wherein at least a portion of the heat resistant material is external to at least one of the first and second forming parts.

19. The forming device of claim 16, further comprising a cooling medium positioned at the first position.

20. The forming device of claim 16, further comprising a protrusion positioned between the first position and the second position.
